(19) United States
(12) Patent Application Publication
(10) Pub. No.: US 2026/0118962 A1
(43) Pub. Date: Apr. 30, 2026

(54) CARRIAGE OF CODED HAPTICS DATA IN MEDIA CONTAINERS

(71) Applicant: InterDigital VC Holdings, Inc., Wilmington, DE (US)

(72) Inventors: Ahmed Hamza, Coquitlam (CA); Gurdeep Bhullar, Montreal (CA)

(21) Appl. No.: 19/118,664

(22) PCT Filed: Oct. 18, 2023
(86) PCT No.: PCT/US2023/035422

§ 371 Date: Apr. 4, 2025

Related U.S. Application Data
(60) Provisional application No. 63/417,638, filed on Oct. 19, 2022.

(51) Int. Cl. G06F 3/01; G06T 13/40; H04N 21/854

(52) U.S. Cl. CPC G06F 3/016; G06T 13/40; H04N 21/85406

(57) ABSTRACT

Systems and methods are described for encoding, processing, and/or decoding a container file, such as an ISOBMFF container file, that represents haptic data. A method according to some embodiments includes: obtaining a container file that includes a plurality of haptics tracks, the container file including information associating each of a plurality of the haptics tracks with at least one of a respective device, a respective perception, or a respective avatar; obtaining information indicating a selection of at least one device, at least one perception, or at least one avatar; and extracting haptics data in response to the selection, wherein the extracted haptics data excludes at least one of the plurality of haptics tracks that is not associated with any selected device, perception, or avatar.

### CROSS-REFERENCE TO RELATED APPLICATION

The present application is a non-provisional filing of, and claims benefit under 35 U.S.C. § 119(e) from, U.S. Provisional Patent Application Ser. No. 63/417,638, filed Oct. 19, 2022, entitled “Carriage of Coded Haptics Data in Media Containers,” which is incorporated herein by reference in its entirety.

### BACKGROUND

A haptic sequence is a set of data encoded for a rendering based on the sense of touch and positioning in space, analogous to how a video sequence is a set of encoded data for a rendering using the sense of vision. A haptic sequence encodes temporal data, for example represented as tracks associated with haptic devices. Haptic devices may render different modalities of the sense of touch and positioning in space like vibration, force, position, velocity, or temperature.

A new standard (ISO/IEC 23090-31) is currently under development by the Motion Picture Experts Group (MPEG). FIG. 2 illustrates the MPEG haptics codec architecture. In this architecture, the coded representation of haptics data may be in one of two formats: an interchange format (.hjif) or distribution format (.hmpg). The interchange format is a JSON-based human readable description of the haptics data while the distribution format is a compressed binary representation of the data. The two formats have complementary purposes, and a lossless or lossy one-to-one conversion can be operated between them. The compressed binary bitstream in the distribution format is structured into a sequence of network abstraction layer (NAL) units to ease encapsulation by any network protocol or file format.

A haptics decoder takes as input a binary ‘.hmpg’ file or a ‘.hjif file and outputs a .hjif file. Haptic data contained in the resulting’.hjif file can then be rendered directly on haptic devices or using an intermediate synthesizer generating pulse code modulation (PCM) data.

FIG. 2 is a functional block diagram illustrating a haptics codec architecture corresponding to ISO/IEC 23090-31. The data structure of the two codec formats follows the hierarchical organization illustrated in FIG. 3.

The highest level of the structure describes the entire haptic experience defined in the file or stream. It contains some high-level metadata information. It also provides a list of avatars (body representations) that can be referenced to specify the desired location of haptic stimuli on the body. The haptic data itself is described through a list of “perceptions.” These perceptions correspond to haptic signals associated with specific perception modalities (vibration, force, position, velocity, temperature, etc.).

In addition to perception-specific metadata, a perception also contains a list of channels. Within the channels, the data is decomposed into frequency bands. Each band defines part of the signal in a given frequency range. The bands are described with a list of haptic effects, each containing a list of keyframes. The haptic signal in a channel can then be reconstructed by combining the data in the different bands (adding the high and low frequency bands).

FIG. 4 illustrates an example of a network abstraction layer (NAL) unit structure in a haptics bitstream. FIG. 5 illustrates NAL unit payload types.

Within the ISO/IEC 14496 (MPEG-4) standard, there are several parts that define file formats for the storage of time-based media. These are all based on and derived from the ISO Base Media File Format (ISOBMFF), which is a structural, media-independent definition. ISOBMFF contains structural and media data information mainly for timed presentations of media data such as audio, video, etc. There is also support for un-timed data, such as meta-data at different levels within the file structure. The logical structure of the file is of a “movie” that in turn contains a set of time-parallel “tracks.” The time structure of the file is that the tracks contain sequences of “samples” in time, and those sequences are mapped into the timeline of the overall movie. ISO BMFF is based on the concept of box-structured files. A box-structured file consists of a series of boxes (sometimes called atoms), which have a size and a type. The types are 32-bit values and usually chosen to be four printable characters, also known a four-character code (4CC). Un-timed data may be contained in a metadata box, at the file level, or attached to the movie box or one of the streams of timed data, called tracks, within the movie.

Among the top-level boxes within an ISOBMFF container is the MovieBox(‘moov’) which contains metadata for the continuous media streams present in the file. These metadata are signaled within the hierarchy of boxes in the Movie box, e.g., within the TrackBox(‘trak’). A track represents a continuous media stream that is present in the file. The media stream itself consists of a sequence of samples, such as audio or video access units of an elementary media stream, and are enclosed within a MediaDataBox(‘mdat’) that is present at the top-level of the container. The metadata for each track includes a list of sample description entries, each providing the coding or encapsulation format used in the track and the initialization data for processing that format. Each sample is associated with one of the sample description entries of the track. ISO/IEC 14496-12 provides a tool for defining an explicit timeline map for each track. This is known as an edit list and is signalled using an EditListBox with the following syntax, where each entry defines part of the track time-line: by mapping part of the composition timeline, or by indicating ‘empty’ time (portions of the presentation timeline that map to no media, an ‘empty’ edit).

```
aligned(8) class EditListBox extends FullBox(‘elst’, version, flags) {
  unsigned int(32) entry_count;
  for (i=1; i <= entry_count; i++) {
    if (version==1) {
      unsigned int(64) edit_duration;
      int(64) media_time;
    } else { // version==0
      unsigned int(32) edit_duration;
      int(32) media_time;
    }
    int(16) media_rate_integer;
    int(16) media_rate_fraction = 0;
  }
}
```

### SUMMARY

Systems and methods are described for encoding and/or decoding a container file, such as an ISOBMFF container file, that represents haptic data. In an example, a haptics experience track is encoded in a container file. The haptics experience track includes information describing at least one available avatar for a haptics experience; and configuration information for at least one perception in the haptics experience. The haptics experience track may further reference at least one haptics track. The haptics tracks may include all bands of a channel for a respective one of the perceptions. The haptics track may have samples that carry haptics band data bitstream units.

Encoder and decoder apparatus are provided to perform the methods described herein. An encoder or decoder apparatus may include a processor configured to perform the methods described herein. The apparatus may include a computer-readable medium (e.g. a non-transitory medium) storing instructions for performing the methods described herein. In some embodiments, a computer-readable medium (e.g. a non-transitory medium) stores haptic data encoded using any of the methods described herein.

A method according to some embodiments includes: obtaining a container file, such as an ISOBMFF file that includes a plurality of haptics tracks, the container file including information associating each of a plurality of the haptics tracks with at least one of a respective device, a respective perception, or a respective avatar; obtaining information indicating a selection of at least one device, at least one perception, or at least one avatar; and extracting haptics data in response to the selection, wherein the extracted haptics data excludes at least one of the plurality of haptics tracks that is not associated with any selected device, perception, or avatar.

In some embodiments, the method is performed by a server, and the information indicating the selection is received from a client device.

Some embodiments further include providing the extracted haptics data to a client device in a bitstream.

Some embodiments further include providing a manifest file indicating at least one available device, at least one available perception, or at least one available avatar, wherein the information indicating the selection is received in response to the manifest file.

Some embodiments further include providing the extracted haptics data to a client device as a container file.

Some embodiments further include rendering the extracted haptics data.

In some embodiments, the information associating a haptics track with a respective device includes a device identifier in a haptics channel configuration box associated with the respective track.

In some embodiments, the information associating a haptics track with a respective perception includes information identifying a track group that includes a plurality of tracks associated with a respective perception.

In some embodiments, the information associating a haptics track with a respective avatar includes an avatar identifier in a haptics perception configuration box.

In some embodiments, the container file includes information associating each of a plurality of the haptics tracks with a respective device, the selection is a selection of at least one device, and the extracted haptics data excludes at least one of the plurality of haptics tracks that is not associated with any selected device.

In some embodiments, an apparatus comprising one or more processors is configured to perform at least: obtaining a container file, such as an ISOBMFF file, that includes a plurality of haptics tracks, the container file including information associating each of a plurality of the haptics tracks with at least one of a respective device, a respective perception, or a respective avatar; obtaining information indicating a selection of at least one device, at least one perception, or at least one avatar; and extracting haptics data in response to the selection, wherein the extracted haptics data excludes at least one of the plurality of haptics tracks that is not associated with any selected device, perception, or avatar.

One or more of the present embodiments also provide a computer readable storage medium having stored thereon instructions for performing any of the methods described herein. Some embodiments include a computer readable storage medium having stored thereon a bitstream or container file generated according to the methods described herein. Some embodiments include a computer program product including instructions for performing any of the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a functional block diagram of a system used in some embodiments described herein.

FIG. 2 illustrates the MPEG haptics codec architecture.

FIG. 3 illustrates the hierarchical data structure of two codec formats.

FIG. 4 illustrates a NAL unit structure in a haptics bitstream.

FIG. 5 illustrates NAL unit payload types.

FIG. 6 illustrates a method performed by a server in some embodiments.

FIG. 7 illustrates a method performed by a client in some embodiments.

### EXAMPLE NETWORKS FOR IMPLEMENTATION OF THE EMBODIMENTS

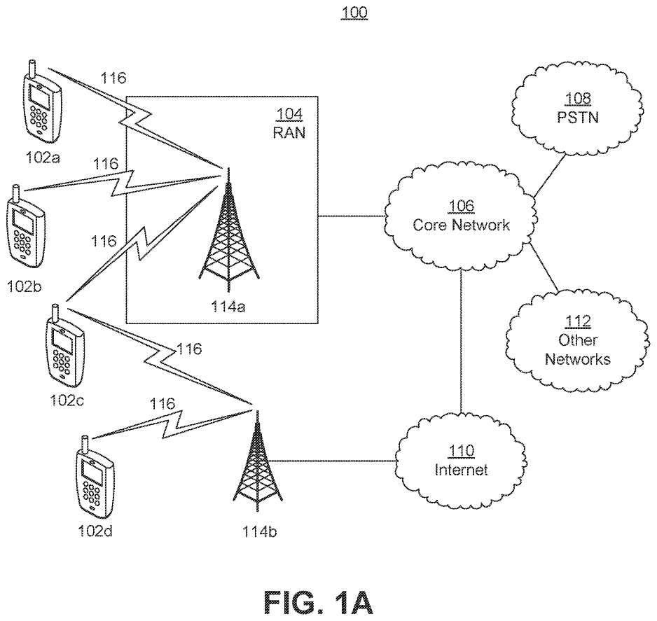

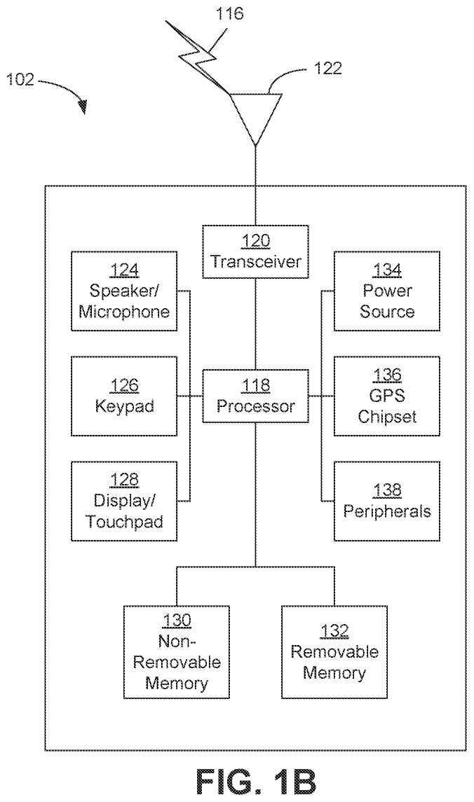

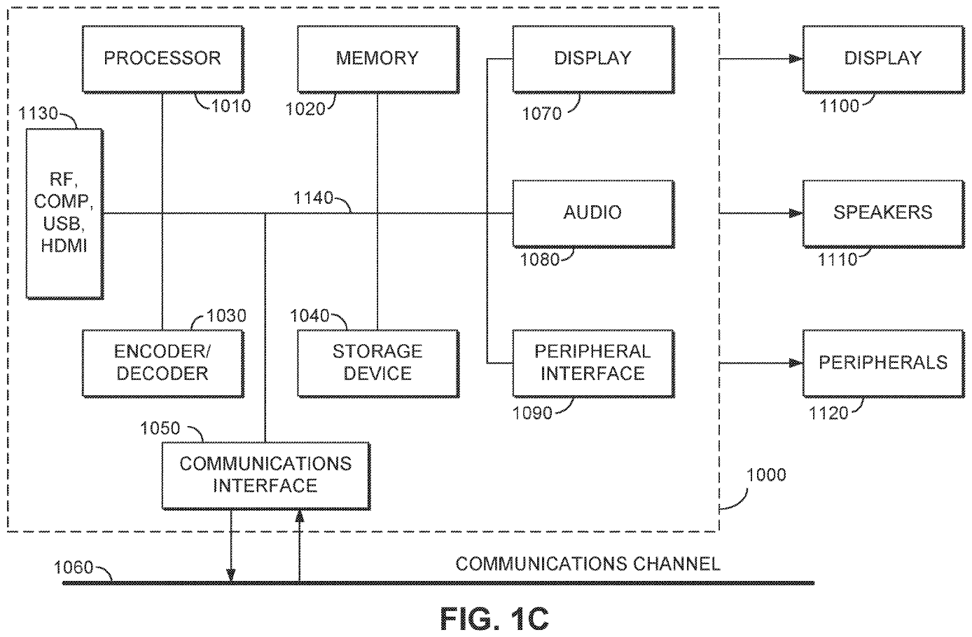

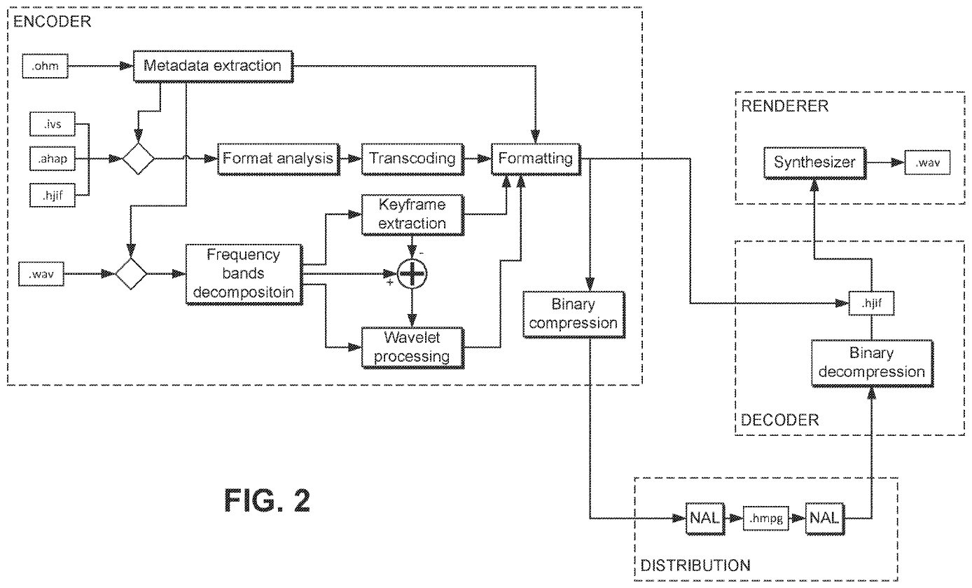

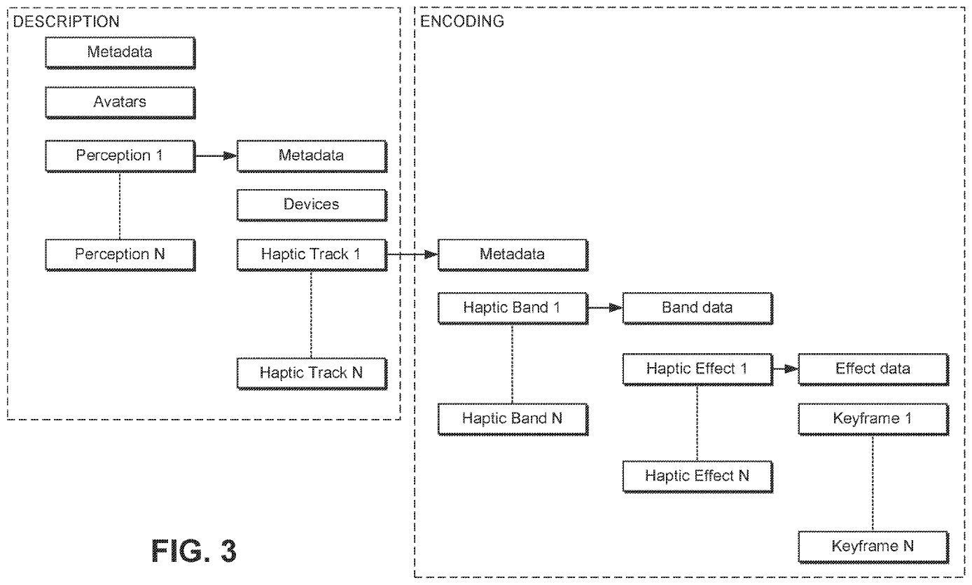

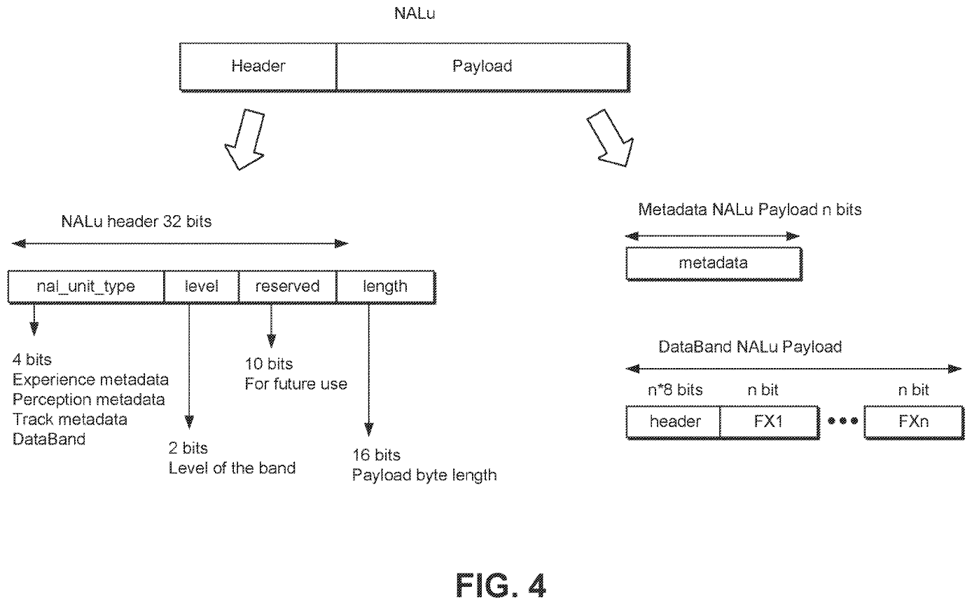

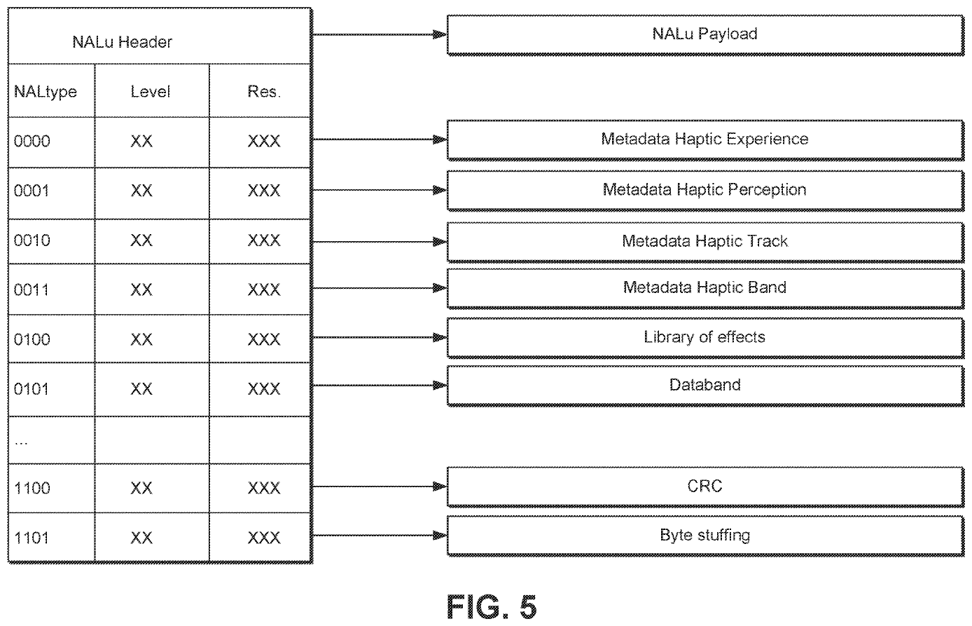

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Example Systems

The embodiments described herein are not limited to being implemented on a WTRU. Such embodiments may be implemented using other systems, such as the system of FIG. 1C. FIG. 1C is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### DETAILED DESCRIPTION

### Issues Addressed in Some Embodiments.

While the bitstream format being developed in ISO/IEC 23090-31 enables describing a haptics experience in compact representation that can be easily consumed by a haptics decoder, the bitstream format does not allow scalable access to different stream components and does not enable selective streaming. Moreover, immersive experiences involve a number of different media types that are synchronized during playback to provide the target experience. There is currently no well-defined method for storing and multiplexing such a haptics bitstream in an ISOBMFF media container with other types of media, such as audio and video.

The present disclosure describes a versatile and scalable design to support carrying a haptics bitstream generated by the ISO/IEC 23090-31 haptics codec in an ISOBMFF container. Example embodiments may be applied to ecosystems involving immersive media coding, storage and streaming of the coded haptics media content and decoding of haptics media data on devices or any services providing an immersive media experience.

### Haptics Experience Track.

In an example embodiment, the main entry to a haptics experience is a Haptics Experience track. A Haptics Experience track may have a sample entry of type HapticsSampleEntry with the ‘hexp’ four-character code (4CC). The HapticsSampleEntry with an ‘hexp’ 4CC contains a HapticsExperienceConfigurationBox which describes the configuration of the haptics experience, including a description of the available avatars in the experience and the configuration of the various perceptions in it. A Haptics Experience track may reference one or more Haptics Tracks. Each Haptics Track may carry band data for a particular channel of a certain perception in the haptics experience.

To link the Haptics Experience track with associated Haptics Track, the track reference tool of ISO/IEC 14496-12 may be used. A TrackReferenceTypeBox with the reference type ‘hpbd’ may be added to a TrackReferenceBox within the TrackBox of the Haptics Experience track. The TrackReferenceTypeBox may contain an array of track_IDS designating the identifiers for the referenced Haptics Tracks.

In another embodiment, each Haptics Track carries all the bands belonging to a particular channel of one of the haptic experience's perceptions.

The HapticsSampleEntry and the HapticsExperienceConfigurationBox may have the following structure.

```
aligned(8) class HapticsSampleEntry(‘hexp’) extends SampleEntry {
  HapticsExperienceConfigurationBox( );
}
aligned(8) class HapticsExperienceConfigurationBox extends
FullBox(‘hexc’, version, flags=0) {
  unsigned int(32) experience_version;
  unsigned int(64) creation_time;
  utf8string description;
  HapticsPerceptionConfigurationBox( );
  HapticsAvatarDescriptionBox( );
}
aligned(8) class HapticsAvatarDescriptionBox extends
FullBox(‘havd’, version=0, flags=0) {
  unsigned int(16) avatar_count;
  for (int i=0; i<avatar_count; i++) {
    unsigned int(32) avatar_id;
    unsigned int(32) level_of_detail;
    unsigned int(2) avatar_type;
    bit(6) reserved = 6;
    if (avatar_type == 0) {
        utf8string mesh_uri;
    }
  }
}
```

In an example, the semantics of the fields of the HapticsExperienceConfigurationBox are as follows:
creation_time is an integer that declares the creation time of this haptics experience (in seconds since midnight, Jan. 1, 1904, in UTC time).
description is a human-readable description of the experience.

In an example, the semantics of the HapticsAvatarDescriptionBox fields are as follows:
avatar_count is the number of avatars available in the haptics experience.
avatar_id is a unique identifier for an avatar.
level_of_detail indicates the level-of-detail of the avatar. The 3D mesh corresponding to an avatar provides high resolution and accuracy with variable vertex density depending on the application. So a certain mesh resolution may be related to the haptic spatial acuity of the relevant haptic perception.
avatar_type indicates the type of haptic perception represented by the avatar based on the spatial acuity of the corresponding haptic modality. Examples of possible values are given in Table 1.

TABLE 1
Avatar types

| Value | Description |
|---|---|
| 0 | Custom |
| 1 | Vibration |
| 2 | Pressure |
| 3 | Temperature |

mesh_uri provides a URI to access an associated custom mesh file for the avatar. Shall only be present if the value for avatar_type is 0.

The avatar_type specifies the type of haptic perception represented by the avatar. Values can be Vibration, Pressure, Temperature or Custom. For “Custom” meshes, the mesh is provided as a companion file. If the type is one of the first three, then the avatar mesh may be pre-defined for an application that targets a specific modality. If you have multiple modalities, then a custom avatar would probably be the best option.

In an example, the HapticsPerceptionConfigurationBox has the following syntax:

```
aligned(8) class HapticsPerceptionConfigurationBox extends
FullBox(‘hpec’, version=0, flags=0) {
  unsigned int(16) perception_count;
  for (int i=0; i<perception_count; i++) {
    HapticsPerception( );
}
}
class HapticsPerception( ) {
  unsigned int(32) perception_id;
  utf8string description;
  unsigned int(4) modality;
  bit(4) reserved = 0;
  unsigned int(32) avatar_id;
  signed int(8) unit_exponent;
  signed int(8) perception_unit_exponent;
  unsigned int(16) channels_count;
  unsigned int(16) devices_count;
  for (int i=0; i<devices_count; i++) {
    HapticsReferenceDevice( );
  }
  HapticsEffectsLibraryBox( ); // optional
}
class HapticsReferenceDevice {
  unsigned int(32) device_id;
  unsigned int(3) device_type;
  bit(5) reserved = 0;
  utf8string name;
  unsigned int(32) body_part_mask;
  unsigned int(16) device_mask;
  if (device_mask != 0) {
    unsigned int(32) maximum_frequency;
    unsigned int(32) minimum_frequency;
    unsigned int(32) resonance_frequency;
    unsigned int(32) maximum_amplitude;
    unsigned int(32) impedance;
    unsigned int(32) maximum_voltage;
    unsigned int(32) maximum_current;
    unsigned int(32) maximum_displacement;
    unsigned int(32) weight;
    unsigned int(32) size;
    unsigned int(32) user_defined_data;
  }
}
```

In an example, the semantics of the HapticsPerceptionConfigurationBox field are as follows.
perception_count is the number of perceptions in the haptics experience.
perception_id is a unique identifier for the perception.
description is a human readable description of the perception.
modality indicates the type of perception. Examples of possible values are given in Table 2.

TABLE 2
Perception modalities

| Value | Description |
|---|---|
| 0 | Other |
| 1 | Pressure |
| 2 | Acceleration |
| 3 | Velocity |
| 4 | Position |
| 5 | Temperature |
| 6 | Vibrotactile |
| 7 | Water |
| 8 | Wind |
| 9 | Force |
| 10 | Vibrotactile Texture |
| 11 | Stiffness |
| 12 | Friction |

avatar_id is the avatar identifier for the avatar body model associated with the perception.
unit_exponent refers to the 10\hat{ }x exponent for the SI unit identifying the space of representation of the independent variable.
perception_unit_exponent refers to the 10\hat{ }x exponent for the SI unit measure of the dependent variable
channels_count is the number of haptics channels for the perception.
devices_count is the number of haptics reference devices associated with the perception.
device_id unique identifier of the device.
device_type indicates the type of actuator. Possible values are given in Table 3.

TABLE 3
Types of reference haptics devices

| Value | Description |
|---|---|
| 0 | Unknown |
| 1 | Linear resonant actuator (LRA) |
| 2 | Voice coil actuator (VCA) |
| 3 | Eccentric rotating mass (ERM) |
| 4 | Piezo |

body_part_mask is a binary mask specifying the location of the device or actuator on the body. The semantics of each bit in the bit mask in an example may be described in the following table.

| | Name | body_part_mask | Hexa | Value |
|---|---|---|---|---|
| 0 | Unspecified | 00000000000000000000000000000000 | 0x00000000 | 0 |
| 1 | Head front | 00000000000000000000000000000001 | 0x00000001 | 1 |
| 2 | Head back | 00000000000000000000000000000010 | 0x00000002 | 2 |
| 3 | Head right | 00000000000000000000000000000100 | 0x00000004 | 4 |
| 4 | Head left | 00000000000000000000000000001000 | 0x00000008 | 8 |
| 5 | Right upper chest | 00000000000000000000000000010000 | 0x00000010 | 16 |
| 6 | Left upper chest | 00000000000000000000000000100000 | 0x00000020 | 32 |
| 7 | Abdomen | 00000000000000000000000001000000 | 0x00000040 | 64 |
| 8 | Waist | 00000000000000000000000010000000 | 0x00000080 | 128 |
| 9 | Upper back | 00000000000000000000000100000000 | 0x00000100 | 256 |
| 10 | Lower back | 00000000000000000000001000000000 | 0x00000200 | 512 |
| 11 | Right upper arm | 00000000000000000000010000000000 | 0x00000400 | 1 024 |
| 12 | Left upper arm | 00000000000000000000100000000000 | 0x00000800 | 2 048 |
| 13 | Right forearm | 00000000000000000001000000000000 | 0x00001000 | 4 096 |
| 14 | Left forearm | 00000000000000000010000000000000 | 0x00002000 | 8 192 |
| 15 | Right wrist | 00000000000000000100000000000000 | 0x00004000 | 16 384 |
| 16 | Left wrist | 00000000000000001000000000000000 | 0x00008000 | 32 768 |
| 17 | Right hand palm | 00000000000000010000000000000000 | 0x00010000 | 65 536 |
| 18 | Left hand palm | 00000000000000100000000000000000 | 0x00020000 | 131 072 |
| 19 | Right hand dorsum | 00000000000001000000000000000000 | 0x00040000 | 262 144 |
| 20 | Left hand dorsum | 00000000000010000000000000000000 | 0x00080000 | 524 288 |
| 21 | Right hand fingers | 00000000000100000000000000000000 | 0x00100000 | 1 048 576 |
| 22 | Left hand fingers | 00000000001000000000000000000000 | 0x00200000 | 2 097 152 |
| 23 | Right thigh | 00000000010000000000000000000000 | 0x00400000 | 4 194 304 |
| 24 | Left thigh | 00000000100000000000000000000000 | 0x00800000 | 8 388 608 |
| 25 | Right calf | 00000001000000000000000000000000 | 0x01000000 | 16 777 216 |
| 26 | Left calf | 00000010000000000000000000000000 | 0x02000000 | 33 554 432 |
| 27 | Right foot palm | 00000100000000000000000000000000 | 0x04000000 | 67 108 864 |
| 28 | Left foot palm | 00001000000000000000000000000000 | 0x08000000 | 134 217 728 |
| 29 | Right foot dorsum | 00010000000000000000000000000000 | 0x10000000 | 268 435 456 |
| 30 | Left foot dorsum | 00100000000000000000000000000000 | 0x20000000 | 536 870 912 |
| 31 | Right foot fingers | 01000000000000000000000000000000 | 0x40000000 | 1 073 741 824 |
| 32 | Left foot fingers | 10000000000000000000000000000000 | 0x80000000 | 2 147 483 648 |

device_mask is a bit mask associated with the device.
maximum_frequency indicates the maximum frequency of the actuator in Hertz (Hz).
minimum frequency indicates the maximum frequency of the actuator in Hertz (Hz).
resonance_frequency indicates the resonance frequency of the actuator in Hertz (Hz).
maximum_amplitude indicates the maximum amplitude value of the target device according to the perception modality.
impedance indicates the impedance of the actuator in ohms (Ω).
maximum_voltage indicates the maximum voltage for the actuator in volts (V).
maximum_current indicates the maximum current for the actuator in amperes (A).
maximum_displacement indicates the maximum displacement of the actuator in millimeters (mm).
weight indicates the weight of the device in kilograms (Kg).
size indicates the size of the device in millimeters (mm).
user_defined_data may be used to specify additional properties for the target device.

In another embodiment, the HapticsPerception data structure is defined as follows, where it contains another dedicated ISOBMFF structure for signaling information regarding the reference device.

```
class HapticsPerception {
  unsigned int(32) perception_id;
  utf8string description
  unsigned int(4) modality;
  bit(4) reserved = 0;
  unsigned int(32) avatar_id;
  signed int(8) unit_exponent;
  signed int(8) perception_unit_exponent;
  unsigned int(16) channels_count;
  HapticsReferenceDevicesBox reference_devices( );
}
```

In an example, the HapticsReferenceDevicesBox may be defined as follows.

```
aligned(8) class HapticsReferenceDevicesBox extends FullBox(‘hrdv’,
0, 0) {
  unsigned int(16) devices_count;
  for (int i=0; i<devices_count; i++) {
    HapticsReferenceDevice( );
}
}
```

In an example, the semantics for the fields of the HapticsReferenceDevicesBox may be as follows:
devices_count is the number of haptics reference devices associated with the perception.

In some embodiments, the HapticsEffectsLibraryBox contains an optional box that may be present when an effects library is present in the haptics perception and band data units may reference the effects in this library instead of carrying the definition of the effects in the band data. The HapticsEffectsLibraryBox may be structured as follows.

```
aligned(8) class HapticsEffectsLibraryBox(band_type) extends
FullBox(‘hfxl’, version=0, flags=0) {
  unsigned int(16) effects_count;
  for (int i=0; i<effects_count; i++) {
    HapticsLibraryEffect effect(band_type);
  }
}
class HapticsLibraryEffect(band_type) {
  unsigned int(32) effect_id;
  unsigned int(2) effect_type;
  bit(6) reserved = 0;
  unsigned int(32) position;
  signed int(16) phase;
if (band_type == 1) {
    unsigned int(3) curve_type;
    bit(5) reserved = 0;
  }
  if (band_type == 2) {
    unsigned int(3) base_signal_type;
    bit(5) reserved = 0;
  }
  // keyframes
  unsigned int(16) keyframe_count;
for (int i=0; i<keyframe_count; i++) {
    HapticsEffectKeyframe(effect_type);
}
}
class HapticsEffectKeyframe(effect_type) {
  // keyframe definition
  unsigned int(32) keyframe_id;
  unsigned int(16) kf_position;
signed int(8) amplitude;
  if ((effect_type == 0) ∥ (effect_type == 2)) {
    unsigned int(16) frequency;
  }
}
```

In an example, the semantics of the fields of the HapticsEffectsLibraryBox are as follows.
effects_count is the number of effects in the effects library.
effect is an instance of HapticsLibraryEffect.
effect_id indicates a unique identifier for the library effect.
effect_type indicates the type of the effect. Examples of allowed values are shown in the following table.

TABLE 4
Haptics effect types

| Value | Description |
|---|---|
| 0 | Basis |
| 1 | Reference |
| 2 | Timeline |

position indicates the temporal position of the effect relative to the beginning of the experience.
phase indicates the phase of the effect.
band_type indicates the type of the data in the band. Examples of possible values are given in Table 5.

TABLE 5
Band types

| Value | Description |
|---|---|
| 0 | Transient |
| 1 | Curve |
| 2 | Vectorial wave |
| 3 | Not allowed |

curve_type indicates the interpolation function for a band of type “curve”. It is only present if the value of band_type is 1. Examples of possible values are given in Table 6.

TABLE 6
Curve band types

| Value | Description |
|---|---|
| 0 | Unknown |
| 1 | Cubic |
| 2 | Linear |
| 3 | Akima |
| 4 | Bezier |
| 5 | BSpline |

base_signal_type indicates the type of the base signal. Examples of possible values are given in Table 7.

TABLE 7
Base signal types

| Value | Description |
|---|---|
| 0 | Sine |
| 1 | Square |
| 2 | Triangle |
| 3 | Sawtooth Up |
| 4 | Sawtooth Down |

timeline_effects_count indicates the number of effects available in the timeline for this band.
keyframe_id is a unique identifier for the keyframe of an effect.
amplitude is the amplitude of the keyframe.
position is the relative position of the keyframe.
frequency is the relative frequency of the keyframe.

In another embodiment, the HapticsEffectsLibraryBox may be defined as follows.

```
aligned(8) class HapticsEffectsLibraryBox(band_type) extends
FullBox(‘hfxl’, 0, 0) {
  unsigned int(16) effects_count;
  for (int i=0; i<effects_count; i++) {
    band_data_unit( );
  }
}
```

The semantics of the fields of the HapticsEffectsLibraryBox in this embodiment may be as follows.
band_data_unit is an instance of a bitstream data unit carrying band data.

### Haptics Track.

According to some embodiments, a Haptics Track is provided as a track whose samples carry haptics band data bitstream units. Similar to a Haptics Experience Track, a Haptics Track also contains a HapticsSampleEntry, but with a different 4CC type. To distinguish between a Haptics Track with samples carrying data for a single band of a perception and channel combination and a Haptics Track where the samples carry data for all the bands of a certain perception channel, two different 4CCs may be used. For example, a ‘hpd1’ 4CC may be used for the former, while a ‘hpd2’ 4CC may be used for the latter.

In some embodiments, the definition of a HapticsSampleEntry of type ‘hpd1’ is as follows:

```
aligned(8) class HapticsSampleEntry(‘hpd1’) extends SampleEntry {
  HapticsChannelConfigurationBox( );
  HapticsBandConfigurationBox( );
}
```

In some embodiments, the definition of the HapticsChannelConfigurationBox is as follows.

```
aligned(8) class HapticsChannelConfigurationBox extends
FullBox(‘hchC’, version=0, flags=0) {
  unsigned int(32) channel_id;
  unsigned int(1) direction_present_flag;
  bit(7) reserved = 0;
  unsigned int(16) device_id;
  unsigned int(32) gain;
  unsigned int(32) mixing_weight;
  bit(32) body_part_mask;
  unsigned int(32) frequency_sampling;
if (frequency_sampling != 0) {
    unsigned int(32) samples_count;
  }
  unsigned int(16) bands_count;
  if (direction_present_flag == 1) {
    signed int(32) direction_x;
    signed int(32) direction_y;
    signed int(32) direction_z;
  }
  unsigned int(32) vertices_count;
  for (int i=0; i<vertices_count; i++) {
    vertex( );
  }
}
```

The corresponding semantics for the fields of HapticsChannelConfigurationBox may be as follows:
channel_id is a unique identifier for the channel.
direction_present_flag is a flag indicating whether a direction is associated with this channel.
device_id is an identifier for a reference device associated with this channel.
gain Indicates a gain associated with the channel to adapt the normalized encoded data values to a typical device.
mixing_weight indicates the weight of the channel when mixing different channels together to produce a final signal.
body_part_mask is a bit mask indicating which the location of the effect on the body.
frequency_sampling indicates the sampling frequency of the original encoded signal in Hertz (Hz).
samples_count indicates the number of sample of the original encoded signal. This field is present if frequency_sampling value is greater than 0.
bands_count is the number of bands available for this channel.
direction_x indicates the horizontal direction to the left/right of the local space.
direction_y indicates the vertical direction up/down of the local space
direction_z indicates the direction forward/backward in the local space.
vertices_count is the number of avatar vertices impacted by the effect.

In some embodiments, the definition of the HapticsBandConfigurationBox is as follows:

class HapticsBandConfigurationBox extends FullBox(‘hbdC’, version=0,
flags=0) {
unsigned int(32) band_id;
unsigned int(2) band_type;
if (band_type == 1) {
unsigned int(3) curve_type;
}
if ((band_type == 2) ∥ (band_type == 3)) {
unsigned int(3) window_length;
}
unsigned int(16) freq_low;
unsigned int(16) freq_high;
}

In an example, the semantics for the fields of the HapticsBandConfigurationBox may be as follows.
band_id is a unique identifier for the band.
band_type indicates the type of the band. Examples of possible values are given in Table 8.

TABLE 8
Band types

| Value | Description |
|---|---|
| 0 | Transient |
| 1 | Curve |
| 2 | Vectorial wave |
| 3 | Wavelet wave |

curve_type indicates the interpolation function used if the band_type is of value 1 (i.e., a curve band).
window length is the duration of the haptic keyframe.
freq_low is the lower frequency limit of the band.
freq_high is the upper frequency limit of the band.

### Haptics Track Samples.

Depending on the sample entry type, as defined by the 4CC of the sample entry, for the Haptics Track, the samples of this track may carry either data for only one band of a perception channel or all the bands of a perception channel. When all the bands are carried in the samples of the Haptics Track, each sample may be composed of a number of sub-samples, where each sub-sample contains data for one of the bands.

In another embodiment, the keyframes for the haptics effects of a channel band may be stored in separate samples in the Haptics Track where each sample is assigned a decoding timestamp and composition timestamp the corresponds to the relative position of the keyframe with respect to the beginning of the haptics experience. To identify the samples belonging to a certain effect, a number of sample groups may be defined in the metadata of the ISOBMFF track. Each sample containing data for non-dependent keyframes, e.g. the first keyframe of an effect, may be designated as a sync sample that enables random access in the track.

### Grouping Haptics Tracks of a Haptics Perception.

When multiple Haptics Tracks are used to carry the band data of the various channels of the haptic experience perceptions, track grouping may be used in some embodiments to identify which Haptic Tracks are associated with a certain haptics perception.

This may be done in some embodiments by defining a track group type that extends TrackGroupTypeBox defined in ISO/IEC 14496-12 which contains a track_group_id that represents an identifier for the track group and a track_group_type field which stores a four-character code identifying the group type. The pair of track_group_id and track_group_type identifies a track group within the container file.

An example HapticsTrackGroupBox may be defined in some embodiments as follows.

| | |
|---|---|
| Box Type: | ‘hptg’ |
| Container: | TrackGroupBox |
| Mandatory: | No |
| Quantity: | Zero or more |

aligned(8) class HapticsTrackGroupBox extends
TrackGroupTypeBox(‘hptg’) {
// additional data related to the haptics perception can be defined here
}

### Example Methods and Systems

With the use of systems, methods, and data structures as described herein, a player is able to extract only the bitstream elements that it needs, for example only the bitstream elements that are relevant to a particular avatar, or those bitstream elements that belong to a certain perception. This may be particularly useful in the context of streaming. In the case of streaming, the exposure may be included in a manifest file.

In contrast with systems that use only a single track to carry the haptics bitstream, example embodiments allow for the use of a multi-track design, where data that belong to certain channels and/or perceptions are carried in their own track. In some embodiments, all of the band data for a certain effect is provided in one sample. Some embodiments allow for a parser to extract certain bands from the sample by using sub-samples. The systems and methods described herein allow for a container file to be structured in a way that makes it easier for a player to extract only the necessary data.

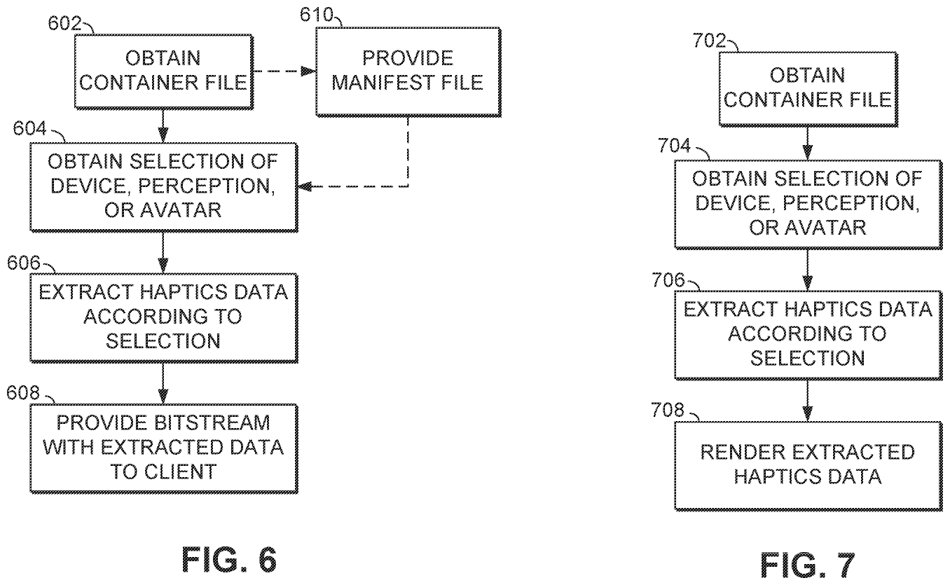

In an example method as shown in the flowchart of FIG. 6, a method performed in some embodiments includes obtaining at 602 a container file that includes a plurality of haptics tracks, the container file including information associating each of a plurality of the haptics tracks with at least one of a respective device, a respective perception, or a respective avatar. At 604, information is obtained that indicates a selection of at least one device, at least one perception, or at least one avatar. At 606, haptics data is extracted in response to the selection, wherein the extraction is performed so as to exclude at least one of the plurality of haptics tracks that is not associated with any selected device, perception, or avatar. For example, the extracted haptics data may include all tracks that are associated with at least one selected device, perception, or avatar, and in some embodiments, all remaining haptics tracks are excluded from the extracted data. In some embodiments, the extracted haptics data may include all tracks that are associated with a selected device, a selected perception, and a selected avatar, and in some embodiments, all remaining haptics tracks are excluded from the extracted data.

In some embodiments, the method of FIG. 6 may be performed by a server, and the selection information received at 604 may be received from a client device. In some such embodiments, the extracted haptics data may be provided to the client device in a bitstream. In some such embodiments, the server optionally at 610 provides a manifest file indicating at least one device, at least one available perception, or at least one available avatar, wherein the information indicating the selection is received in response to the manifest file.

As an example, a server may obtain a container file with a first plurality of haptics tracks associated with first perception and a second plurality of haptics tracks associated with a second perception. The first perception may include information indicating that the modality of the first perception is “wind”. The second perception may include information indicating that the modality of the second perception is “vibrotactile”. The server may use metadata in the container file to provide a manifest file (e.g. at 610) with information characterizing the first and second perception. In response to the manifest file, a client may request only the second perception (vibrotactile) and not the first perception (wind). For example, the client may not have any apparatus capable of rendering a “wind” sensation, or the user may prefer not to experience a simulated wind. In response to the client selection, haptic data provided to the client excludes data based on tracks associated with the first perception. Similar selections may be made based on available avatars and/or available devices. For example, a client may not have some types of haptics devices, so only haptics data related to devices the client does have may be streamed to the client.

In an example method as shown in the flowchart of FIG. 7, a method performed in some embodiments includes obtaining at 702 a container file that includes a plurality of haptics tracks, the container file including information associating each of a plurality of the haptics tracks with at least one of a respective device, a respective perception, or a respective avatar. At 704, information is obtained that indicates a selection of at least one device, at least one perception, or at least one avatar. This information may include configuration information regarding the types of haptics devices available to a user and/or the types of haptic experiences a user enjoys or would prefer to avoid. At 706, haptics data is extracted in response to the selection, wherein the extraction is performed so as to exclude at least one of the plurality of haptics tracks that is not associated with any selected device, perception, or avatar. At 708, a client may render the extracted haptics data using appropriate actuators.

### Further Embodiments

A method according to some embodiments comprises encoding in a container file a haptics experience track, wherein the haptics experience track includes: information describing at least one available avatar for a haptics experience; and configuration information for at least one perception in the haptics experience.

A method according to some embodiments comprises decoding from a container file a haptics experience track, wherein the haptics experience track includes: information describing at least one available avatar for a haptics experience; and configuration information for at least one perception in the haptics experience.

In some embodiments, the haptics experience track further references at least one haptics track. For example, the haptics experience track may include an array of identifiers of respective referenced haptics tracks.

In some embodiments, each of the haptics tracks includes all bands of a channel for a respective one of the perceptions.

In some embodiments, the haptics track incudes band data for a channel of the at least one perception.

In some embodiments, the haptics track is a track having samples that carry haptics band data bitstream units.

In some embodiments, the haptics track includes a code indicating whether (i) the haptics track includes samples carrying data for a single band of a perception and channel combination, or (ii) the haptics track includes samples that carry data for all the bands of a certain perception channel.

In some embodiments, the samples of a haptics track contain data for only one band of a perception channel.

In some embodiments, the samples of a haptics track contain data for all bands of a perception channel. In some such embodiments, each of the samples includes a plurality of sub-samples, and each of the sub-samples includes data for one of the bands.

In some embodiments, a plurality of the samples are keyframe samples.

In some embodiments, a plurality of the keyframe samples are designated as sync samples.

In some embodiments, the file includes metadata defining at least one sample group, the samples in a common sample group being samples that belong to a designated effect.

In some embodiments, the file further includes haptics track group information associating a plurality of haptics tracks with a corresponding haptics track group.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present disclosure, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. A mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining a container file that includes a plurality of haptics tracks, the container file including information associating each of a plurality of the haptics tracks with at least one of a respective device, a respective perception, or a respective avatar;
obtaining information indicating a selection of at least one device, at least one perception, or at least one avatar; and
extracting haptics data in response to the selection, wherein the extracted haptics data excludes at least one of the plurality of haptics tracks that is not associated with any selected device, perception, or avatar.

2. The method of claim 1, wherein the method is performed by a server, and the information indicating the selection is received from a client device.

3. The method of claim 1, further comprising providing the extracted haptics data to a client device in a bitstream.

4. The method of claim 1, further comprising providing a manifest file indicating at least one available device, at least one available perception, or at least one available avatar, wherein the information indicating the selection is received in response to the manifest file.

5. The method of claim 1, further comprising providing the extracted haptics data to a client device as a container file.

6. The method of claim 1, further comprising rendering the extracted haptics data.

7. The method of claim 1, wherein the information associating a haptics track with a respective device includes a device identifier in a haptics channel configuration box associated with the respective track.

8. The method of claim 1, wherein the information associating a haptics track with a respective perception includes information identifying a track group that includes a plurality of tracks associated with a respective perception.

9. The method of claim 1, wherein the information associating a haptics track with a respective avatar includes an avatar identifier in a haptics perception configuration box.

10. The method of claim 1, wherein the container file includes information associating each of a plurality of the haptics tracks with a respective device, the selection is a selection of at least one device, and the extracted haptics data excludes at least one of the plurality of haptics tracks that is not associated with any selected device.

11. The method of claim 1, wherein the container file is an ISOBMFF file.

12. An apparatus comprising one or more processors configured to perform at least:
obtaining a container file that includes a plurality of haptics tracks, the container file including information associating each of a plurality of the haptics tracks with at least one of a respective device, a respective perception, or a respective avatar;
obtaining information indicating a selection of at least one device, at least one perception, or at least one avatar; and
extracting haptics data in response to the selection, wherein the extracted haptics data excludes at least one of the plurality of haptics tracks that is not associated with any selected device, perception, or avatar.

13. The apparatus of claim 12, further configured to provide the extracted haptics data to a client device in a bitstream.

14. The apparatus of claim 12, further comprising providing the extracted haptics data to a client device as a container file.

15. The apparatus of claim 12, further comprising rendering the extracted haptics data.
